(19) United States
(12) Patent Application Publication
(10) Pub. No.: US 2012/0325724 A1
(43) Pub. Date: Dec. 27, 2012

(54) RECOVERY OF ALKYL CHLORIDE ADSORBTION CAPACITY BY BASIC SOLUTION TREATMENT OF SPENT ADSORBENT

(76) Inventors: Michael S. Driver, San Francisco, CA (US); Hye Kyung Timken, Albany, CA (US)

(21) Appl. No.: 13/169,695

(22) Filed: Jun. 27, 2011

(51) Int. Cl. C10G 25/12; B01J 38/64

(52) U.S. Cl. 208/262.1; 502/25

(57) ABSTRACT

Processes for the rejuvenation of a spent adsorbent, wherein the adsorption capacity of the spent adsorbent may be repeatedly restored by treating the spent adsorbent with a basic solution and subsequent adsorbent activation, thereby allowing a plurality of adsorption cycles using a single adsorbent sample. Processes for ionic liquid catalyzed hydrocarbon conversion and hydrocarbon product purification are also disclosed.

### TECHNICAL FIELD

The present invention relates to the recovery of alkyl chloride adsorption capacity by basic solution treatment of spent adsorbent.

### BACKGROUND

The conversion by refining industries of light paraffins and light olefins to more valuable cuts has been accomplished by the alkylation of paraffins with olefins and by the oligomerization of olefins. Such processes, which have been used since the 1940's, continue to be driven by the increasing demand for high quality and clean burning high-octane gasoline, distillate, and lubricating base oil.

Conventional alkylation processes use vast quantities of H₂SO₄ or HF as catalyst. The quest for an alternative catalytic system to replace the H₂SO₄ or HF catalysts has been researched by various groups in both academic and industrial institutions. Thus far, no viable replacement to the conventional processes has been commercialized.

Recently there has been considerable interest in metal halide ionic liquid catalysts as alternatives to H₂SO₄ or HF catalysts. As an example, the ionic liquid catalyzed alkylation of isoparaffins with olefins is disclosed in U.S. Pat. No. 7,432,408 to Timken et al. Further, U.S. Pat. No. 7,572,943 to Elomari et al. discloses the ionic liquid catalyzed oligomerization of olefins and the alkylation of the resulting oligomers(s) with isoparaffins to produce alkylated olefin oligomers.

The presence of HCl as a co-catalyst with an ionic liquid provides an increased level of catalytic activity, for example, as disclosed by the '408 patent. Typically, anhydrous HCl co-catalyst or an organic chloride catalyst promoter may be combined with the ionic liquid feed to attain the desired level of catalytic activity and selectivity (see, e.g., U.S. Pat. Nos. 7,495,144 to Elomari, and 7,531,707 to Harris et al.). When organic chloride is used as a catalyst promoter with the ionic liquid, HCl may be formed in situ in the reactor during the hydrocarbon conversion process.

Hydrocarbon product(s) of ionic liquid catalyzed hydrocarbon conversions, such as alkylate or distillate or base oil, typically contain substantial amounts of organic chloride components that are produced during the reaction. In addition, some unconverted organic chloride catalyst promoter may also be carried over into such hydrocarbon products. The removal of organic chloride components from the hydrocarbon products may be desirable, e.g., to prevent the formation of unwanted byproducts during combustion of liquid fuels (see, for example, U.S. Pat. No. 7,538,256 to Driver et al., and U.S. Patent Application No. 2009/0163750 A1 (Timken, et al.)).

There is a need for processes for the efficient purification of hydrocarbon products derived from ionic liquid catalyzed hydrocarbon conversion reactions.

### BRIEF DESCRIPTION OF THE DRAWINGS

FIG. 1 represents a scheme for a hydrocarbon conversion and hydrocarbon product purification process, according to an embodiment of the present invention.

### SUMMARY

In an embodiment, the present invention provides processes for the purification of a hydrocarbon product derived from an ionic liquid catalyzed hydrocarbon conversion reaction, wherein an adsorbent may be used for adsorbing at least one organic halide contaminant of the hydrocarbon product. The present invention also provides processes for the rejuvenation of spent adsorbent, wherein adsorbent that has become spent due to the adsorption of organic halides may be treated to regain its adsorption capacity for organic halides. Such rejuvenated adsorbent may subsequently undergo repetitive cycles of adsorption and rejuvenation to greatly extend the useful lifetime of the adsorbent. In an embodiment, methods of the invention may be used to improve the operability and economics of ionic liquid catalyzed hydrocarbon conversion processes.

According to one aspect of the present invention there is provided a process for treating a spent adsorbent, the process comprising contacting the spent adsorbent with a basic solution under adsorbent dechlorination conditions, wherein the spent adsorbent includes at least one halogenated component; and removing at least a portion of the at least one halogenated component from the spent adsorbent to provide a dechlorinated adsorbent.

In an embodiment, the present invention also provides a process comprising contacting a hydrocarbon product comprising an organic halide with an adsorbent under organic halide adsorption conditions to provide a purified hydrocarbon product and a spent adsorbent, wherein a first chloride content of the hydrocarbon product is greater than a second chloride content of the purified hydrocarbon product; contacting the spent adsorbent with a basic solution under adsorbent dechlorination conditions to provide a dechlorinated adsorbent; and activating the dechlorinated adsorbent to provide a rejuvenated adsorbent.

In another embodiment, the present invention further provides a process for providing a purified hydrocarbon product, the process comprising contacting at least one hydrocarbon reactant with an ionic liquid catalyst in a hydrocarbon conversion zone under hydrocarbon conversion conditions to provide a hydrocarbon product comprising an organic halide contaminant; contacting the hydrocarbon product with an adsorbent in an adsorption zone under organic halide adsorption conditions to provide: i) the purified hydrocarbon product, and ii) spent adsorbent; contacting the spent adsorbent with a basic solution under adsorbent dechlorination conditions to provide a dechlorinated adsorbent; and activating the dechlorinated adsorbent to provide a rejuvenated adsorbent.

As used herein, the terms “comprising” and “comprises” mean the inclusion of named elements or steps that are identified following those terms, but not necessarily excluding other unnamed elements or steps.

### DETAILED DESCRIPTION

Ionic liquid catalysts may be useful for a range of hydrocarbon conversion reactions, including paraffin alkylation, paraffin isomerization, olefin isomerization, olefin dimerization, olefin oligomerization, olefin polymerization, and aromatic alkylation.

Hydrocarbon products derived from ionic liquid catalyzed processes may contain undesirably high levels of organic halides, e.g., various alkyl chlorides. According to one aspect of the invention, such hydrocarbon products may be efficiently dechlorinated by contact with an adsorbent in an adsorption zone under suitable adsorption conditions to provide a purified hydrocarbon product. With continued use the adsorbent may become at least partially spent, and the capacity of the adsorbent to adsorbe alkyl chlorides will decline.

Applicants have discovered that spent adsorbent, e.g., having lost at least a substantial amount of its original alkyl chloride adsorption capacity, may be rejuvenated to restore the alkyl chloride adsorption capacity of the adsorbent. As an example, a spent adsorbent may have lost at least about 50%-75% of its original alkyl chloride adsorption capacity; in contrast, after rejuvenation according to embodiments of the instant invention the alkyl chloride adsorption capacity of the rejuvenated adsorbent may be restored to at least about 70% of the original adsorption capacity.

Furthermore, applicants have discovered that the adsorbent may undergo a plurality of adsorption and rejuvenation cycles, with no significant further diminution in alkyl chloride adsorption capacity of the adsorbent. The rejuvenated adsorbent may be used according to embodiments of the instant invention to provide purified hydrocarbon products having a chloride content low enough for blending into refinery products.

The terms “absorption” and “adsorption” as used herein refer to the retention or accumulation of a material on or within another material, and for purposes of the present invention the two terms may be used interchangeably.

The term “alkyl chloride adsorption capacity” as used herein refers to the capacity of an adsorbent to adsorbe alkyl chloride. The alkyl chloride adsorption capacity of a given adsorbent may be expressed quantitatively, for example, as the number of grams of chloride adsorbed per gram of the adsorbent.

A “basic solution” may be prepared by dissolving a Group 1 or Group 2 metal hydroxide (current IUPAC version of the periodic table) in a suitable solvent. The solvent may be a polar solvent such as water. When a basic solution is prepared with water as the solvent, the pH of the solution is greater than pH 7, in an embodiment greater than 9, and in another embodiment greater than 12. The metal hydroxide may be selected, for example, from NaOH, KOH, RbOH, CsOH, Mg(OH)₂, Ca(OH)₂, Sr(OH)₂, Ba(OH)₂, and combinations thereof. As an example, a basic solution for practicing the invention may be a purchased caustic material or may be derived from such material.

The term “fresh adsorbent” as used herein refers to an adsorbent that has been dried and/or thermally treated and has not previously been used for adsorption.

The term “dechlorinated adsorbent” as used herein refers to an adsorbent that has been treated to remove at least a portion of one or more halogenated components from the adsorbent.

The term “rejuvenated adsorbent” as used herein refers to an adsorbent that has been used for adsorption and that has subsequently been treated to increase its adsorption capacity.

### Ionic Liquid Catalysts

Ionic liquids are generally organic salts with melting points below 100° C. and often below room temperature. They may find applications in various chemical reactions, solvent processes, and electrochemistry. The use of chloroaluminate ionic liquids as alkylation catalysts in petroleum refining has been described, for example, in commonly assigned U.S. Pat. Nos. 7,531,707, 7,569,740, and 7,732,654, the disclosure of each of which is incorporated by reference herein in its entirety.

Most ionic liquids are prepared from organic cations and inorganic or organic anions. Cations include, but are not limited to, ammonium, phosphonium and sulphonium. Anions include, but are not limited to, BF₄⁻, PF₆⁻, haloaluminates such as AlCl₄⁻, Al₂Cl₇⁻, AlBr₄⁻, and Al₂Br⁻, [(CF₃SO₂)₂N]⁻, alkyl sulfates (RSO₃⁻), and carboxylates (RCO₂⁻). Ionic liquids for acid catalysis may include those derived from ammonium halides and Lewis acids, such as AlCl₃, TiCl₄, SnCl₄, and FeCl₃. Chloroaluminate ionic liquids are perhaps the most commonly used ionic liquid catalyst systems for acid catalyzed reactions.

Exemplary ionic liquids that may be used in practicing the instant invention may comprise at least one compound of the general formulas A and B:

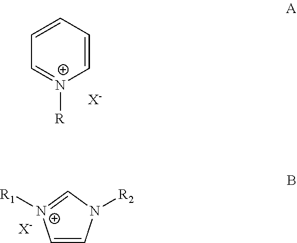

wherein R is selected from the group consisting of H, methyl, ethyl, propyl, butyl, pentyl or hexyl, each of R₁ and R₂ is selected from the group consisting of H, methyl, ethyl, propyl, butyl, pentyl or hexyl, wherein R₁ and R₂ may or may not be the same, and X is a chloroaluminate.

Examples of chloroaluminate ionic liquid catalysts that may be used in practicing the instant invention include those comprising 1-butyl-4-methyl-pyridinium chloroaluminate, 1-butyl-3-methyl-imidazolium chloroaluminate, 1-H-pyridinium chloroaluminate, N-butylpyridinium chloroaluminate, and combinations thereof.

### Feedstocks for Ionic Liquid Catalyzed Processes

In an embodiment, feeds for the present invention may comprise various streams in a petroleum refinery, a gas-to-liquid conversion plant, a coal-to-liquid conversion plant, or in naphtha crackers, middle distillate crackers, or wax crackers, including FCC off-gas, FCC light naphtha, coker off-gas, coker naphtha, hydrocracker naphtha, and the like. In an embodiment, such streams may contain isoparaffin(s) and/or olefin(s).

Examples of olefin containing streams include FCC off-gas, coker gas, olefin metathesis unit off-gas, polyolefin gasoline unit off-gas, methanol to olefin unit off-gas, FCC light naphtha, coker light naphtha, Fischer-Tropsch unit condensate, and cracked naphtha. Some olefin containing streams may contain two or more olefins selected from ethylene, propylene, butylenes, pentenes, and up to C₁₀ olefins. Such olefin containing streams are further described in U.S. Pat. No. 7,572,943, the disclosure of which is incorporated by reference herein in its entirety.

Examples of isoparaffin containing streams include, but are not limited to, FCC naphtha, hydrocracker naphtha, coker naphtha, Fisher-Tropsch unit condensate, and cracked naphtha. Such streams may comprise a mixture of two or more isoparaffins. In a sub-embodiment, a feed for an ionic liquid catalyzed process of the invention may comprise isobutane, which may be obtained, for example, from a hydrocracking unit or may be purchased.

In an embodiment, olefins and isoparaffins in the feed(s) may participate in ionic liquid catalyzed isoparaffin-olefin alkylation reactions. In another embodiment, olefins in the feed(s) may undergo oligomerization when contacted with an ionic liquid catalyst in a hydrocarbon conversion reactor. Ionic liquid catalyzed olefin oligomerization may take place under the same or similar conditions as ionic liquid catalyzed olefin-isoparaffin alkylation. Ionic liquid catalyzed olefin oligomerization and olefin-isoparaffin alkylation are disclosed, for example, in commonly assigned U.S. Pat. Nos. 7,572,943 and 7,576,252, both to Elomari et al., the disclosures of which are incorporated by reference herein in their entirety.

### Ionic Liquid Catalyzed Hydrocarbon Conversion Processes

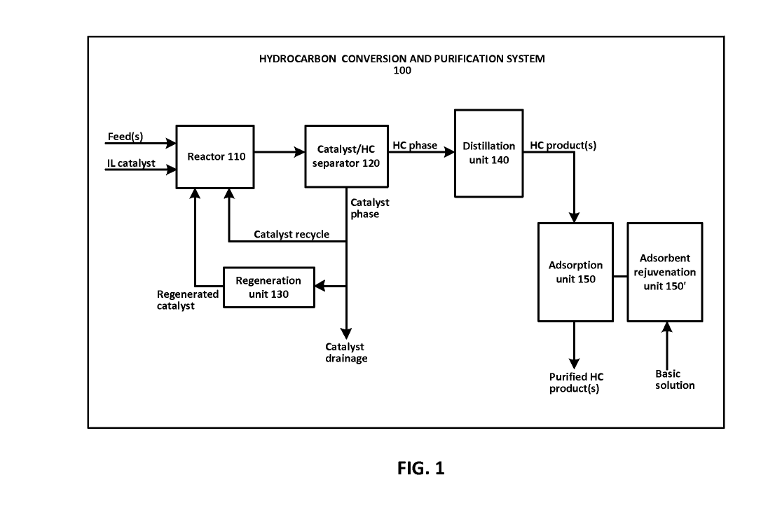

A scheme for an ionic liquid catalyzed hydrocarbon conversion process and system is shown in FIG. 1. Hydrocarbon conversion and purification system 100 may include a reactor 110, a catalyst/hydrocarbon (HO) separator 120, a catalyst regeneration unit 130, a distillation unit 140, and an adsorption unit 150. Reactor 110 may also be referred to herein as a hydrocarbon conversion zone.

Dry feed(s) may be introduced into reactor 110 via one or more reactor inlet ports (not shown). Ionic liquid catalyst may be introduced into reactor 110 via a separate inlet port (not shown). The ionic liquid catalyst may comprise a chloroaluminate ionic liquid. In an embodiment, system 100 may be used in ionic liquid catalyzed hydrocarbon conversion processes for the production of hydrocarbon products, such as alkylate gasoline, middle distillate fuels, base oil, and the like.

As an example only, the feed(s) to reactor 110 during alkylate gasoline production may comprise a first reactant comprising a C₄-C₁₀ isoparaffin and a second reactant comprising a C₂-C₁₀ olefin. Ionic liquid catalyzed alkylation processes are disclosed in commonly assigned U.S. Pat. Nos. 7,531,707, 7,569,740, and 7,732,654, the disclosure of each of which is incorporated by reference herein in its entirety.

The feeds to reactor 110 may further include a co-catalyst, such as HCl, or a catalyst promoter, such as an alkyl halide. In an embodiment, a portion of an unconverted alkyl halide catalyst promoter may be carried over into an unfinished hydrocarbon product from reactor 110. In a sub-embodiment, the catalyst promoter may comprise a C₄ alkyl chloride, such as n-butyl chloride or t-butyl chloride.

As an example only, the reaction conditions for an ionic liquid catalyzed process of the instant invention may generally include a catalyst volume in the reactor in the range from about 5 vol % to 50 vol %, a temperature of from about −10° C. to 100° C., a pressure in the range from about 300 kPa to 2500 kPa, an isoparaffin/olefin molar ratio in the range from about 2:1 to 20:1, and a residence time in the range from about 1 min to 1 hour.

Reactor 110 may be vigorously mixed to promote contact between reactant(s) and ionic liquid catalyst. Depending on the choice of ionic liquid, the solubility of hydrocarbons in the ionic liquid phase may be low resulting in a biphasic reaction mixture where the hydrocarbon conversion reactions occur at the interface in the liquid state. Reactor 110 may contain a mixture comprising ionic liquid catalyst and a hydrocarbon phase, wherein the hydrocarbon phase may comprise at least one hydrocarbon product. The ionic liquid catalyst may be separated from the hydrocarbon phase via catalyst/hydrocarbon separator 120, wherein the hydrocarbon and ionic liquid catalyst phases may be allowed to settle under gravity, by using a coalescer, or by a combination thereof.

In an embodiment, at least a portion of the ionic liquid phase may be recycled directly to reactor 110. With the continued operation of system 100, the ionic liquid catalyst may become at least partially deactivated. In order to maintain catalytic activity of the ionic liquid, a portion of the ionic liquid phase may be fed to regeneration unit 130 for regeneration of the ionic liquid catalyst. Methods for the regeneration of chloroaluminate ionic liquid catalysts are disclosed, e.g., in commonly assigned U.S. Pat. Nos. 7,674,739 and 7,691,771, the disclosure of each of which is incorporated by reference herein in its entirety.

The hydrocarbon phase may be fractionated, e.g., via distillation unit 140, for separation of the hydrocarbon product(s). Distillation unit 140 may be adjusted, e.g., with respect to temperature and pressure, to provide at least one hydrocarbon product from the hydrocarbon phase under steady state distillation conditions.

In an embodiment of the present invention, a hydrocarbon product obtained from distillation unit 140 may include at least one organic halide contaminant. In an embodiment, a hydrocarbon product from distillation unit 140 may have an organic chloride content generally in the range from about 50 ppm to 5000 ppm, typically from about 100 ppm to 4000 ppm, and often from about 200 ppm to 3000 ppm.

### Dechlorination of Ionic Liquid Catalyst Derived Hydrocarbon Products

At least one unfinished hydrocarbon product of system 100 may be fed, e.g., from distillation unit 140, to adsorption unit 150 for purifying the hydrocarbon product(s). One or more of the hydrocarbon products may include at least one halogenated component as a contaminant. Adsorption unit 150 may also be referred to herein as an adsorption zone.

In an embodiment of the present invention, an organic halide contaminant in the unfinished hydrocarbon product may comprise one or more alkyl chlorides. In an embodiment, the organic halide contaminant(s) in the hydrocarbon product may comprise a catalyst promoter fed to reactor 110, and/or one or more halogenated reaction byproducts from reactor 110. In an embodiment, the organic halides may comprise one or more C₂-C₁₂ alkyl chlorides, and in some embodiments one or more C₂-C₁₆ alkyl chlorides.

Adsorption unit 150 may include or contain at least one adsorbent. The hydrocarbon product may be contacted with the adsorbent within adsorption unit 150, thereby removing the organic halide contaminants to provide a dechlorinated or purified hydrocarbon product. In an embodiment, the at least one hydrocarbon product may comprise alkylate gasoline, diesel fuel, jet fuel, base oil, or combinations thereof.

During the purification of a hydrocarbon product in adsorption unit 150, organic halide components of the hydrocarbon product may be selectively adsorbed by the adsorbent. As an example, the adsorbent within adsorption unit 150 may comprise a material selected from a molecular sieve, a refractory oxide, an activated carbon, and combinations thereof. In an embodiment, the adsorbent may comprise a refractory oxide selected from alumina, silica, titania, silica-alumina, and zirconia, or the like, and combinations thereof.

In another embodiment, an adsorbent of adsorption unit 150 may comprise a molecular sieve. As a non-limiting example, molecular sieves useful in practicing the instant invention may be selected from the group: large pore zeolites, intermediate pore zeolites, small pore zeolites, and combinations thereof. Zeolites are aluminosilicate molecular sieves with a one to three dimensional structure forming channels and cages with molecular dimensions. The aluminum atoms are tetra-coordinated, developing a negative charge on the structure, which is compensated by the extra framework cations. The Si/Al ratio of zeolites that may be useful in practicing the instant invention may be in the range from 1 to 1000.

Large pore-, intermediate pore-, and small pore molecular sieves having pore sizes from 4 to 16 Angstrom may be used as absorbents to remove organic halide contaminants from the hydrocarbon product(s) of system 100. Some examples of adsorbents that may be useful in practicing the invention include: large pore molecular sieves such as zeolite X, zeolite Y, USY zeolite, mordenite, ALPO-5, SAPO-5, zeolite Beta, ZSM-12, MCM-22, MCM-36, MCM-68, ITQ-7, ITQ-10, ITQ-14, SSZ-24, SSZ-31, SSZ-33, SSZ-48, SSZ-55, SSZ-59 and SSZ-60; intermediate pore molecular sieves such as ZSM-5, ZSM-11, ZSM-22, ZSM-35, ALPO-11, SAPO-11, SSZ-25, SSZ-32, SSZ-35, SSZ-41, and SSZ-44; and small pore molecular sieves such as zeolite A, SSZ-16, SSZ-39, and SSZ-52. In an embodiment, zeolite adsorbents useful in practicing the instant invention may include various extra framework cations such as sodium, potassium, cesium, calcium, magnesium, and barium.

In an embodiment, large pore-, intermediate pore-, and small pore molecular sieves may be used as adsorbents either alone or as mixtures. For example, an adsorbent for practicing the instant invention may comprise a mixture of a large pore zeolite and a small pore zeolite, or a mixture of different small pore zeolites. In a sub-embodiment, the adsorbent may comprise 13× molecular sieve.

According to one aspect of the present invention, a hydrocarbon product of system 100 may be contacted with an adsorbent in adsorption unit 150, under organic halide adsorption conditions sufficient to remove organic halides from the hydrocarbon product, to provide a purified hydrocarbon product having a chloride content suitable for blending into the product blending pool.

In an embodiment, the organic halide adsorption conditions within the adsorption zone may comprise a temperature generally in the range from about 32° F. to 500° F., a pressure generally in the range from about 1 to 1000 psig, and a liquid hourly space velocity (LHSV) feed rate of the hydrocarbon product to the adsorption zone generally in the range from about 0.1 to 40 hr⁻¹.

The adsorbent of adsorption unit 150 may be selective for organic halides, such that at least one C₂-C₁₆ alkyl chloride is selectively adsorbed, while the corresponding (C₂-C₁₆) alkanes may pass through the absorbent. In general, a first chloride content of the hydrocarbon product prior to treatment by adsorption unit 150 may be greater than 50 ppm, and in some embodiments greater than 100 ppm; whereas after treatment by adsorption unit 150, a second chloride content of the purified hydrocarbon product(s) may be less than 50 ppm, and typically less than about 10 ppm.

In an embodiment, the purified hydrocarbon product obtained from adsorption unit 150 may have a much lower chloride content as compared with that of the hydrocarbon product feed to adsorption unit 150. As an example, the hydrocarbon product feed to adsorption unit 150 may have an organic chloride content generally in the range from about 50 ppm to 5000 ppm, typically from about 100 ppm to 4000 ppm, and often from about 200 ppm to 3000 ppm. In contrast, the chloride content of the dechlorinated product will be typically less than 50 ppm, usually less than about 10 ppm, and often less than about 5 ppm. Analogous results will be obtained when the present invention is practiced using ionic liquid catalyst and/or co-catalyst systems based on halides other than chlorides.

In an embodiment, the purified hydrocarbon product obtained from adsorption unit 150 may comprise alkylate gasoline having similar, or substantially the same, characteristics including octane number and boiling point distribution, as compared with an unfinished alkylate gasoline feed to adsorption unit 150. In an embodiment, purified alkylate gasoline obtained from adsorption unit 150 may have a chloride content (e.g., <10 ppm chloride) and other specifications well within acceptable ranges.

In an embodiment, adsorption unit 150 may include two or more adsorption beds (not shown), which may be arranged in series or parallel to facilitate alternating the adsorbent beds between adsorption and rejuvenation modes. For example, after a first adsorbent bed has become spent, the hydrocarbon product may be fed directly to a second adsorbent bed under organic halide adsorption conditions, while the first adsorbent bed may undergo rejuvenation.

### Adsorbent Rejuvenation

A purified hydrocarbon product may be produced using an adsorbent for adsorbing organic halides from an unfinished or contaminated hydrocarbon product, wherein the adsorbent becomes at least partially spent, and the spent adsorbent used for the purification process may be rejuvenated, according to embodiments of the present invention. In another embodiment, a rejuvenated adsorbent may undergo a plurality of successive adsorption and rejuvenation cycles, to greatly increase the useful lifetime of the adsorbent, thereby improving the operability of ionic liquid catalyzed hydrocarbon conversion processes.

Non-limiting examples of various adsorbents that may be useful in practicing embodiments of the instant invention are presented herein. In an embodiment, the adsorbent may comprise a molecular sieve, a refractory metal oxide, an activated carbon, or combinations thereof. In an embodiment, the adsorbent may include a binder material such as clay. The adsorbent may be in a pellet form, e.g., to facilitate loading and unloading.

The adsorbent may be dried to remove any moisture before using it for adsorption purposes. As an example, the adsorbent may be dried under conditions sufficient to remove at least substantially all moisture from the adsorbent, e.g., at a temperature typically above about 200° F., and usually above about 250° F., for a time period of typically at least about 0.5 hr. In an embodiment, an inert gas such as N₂ or air may be passed through the adsorption bed to reduce any degradation of the adsorbent or facile removal of moisture. Adsorbent that has not previously been used for the adsorption of an adsorbate, but has been dried and/or thermally treated, may be referred to herein as “fresh adsorbent.”

Non-limiting examples of hydrocarbon products that may be dechlorinated according to methods of the present invention include alkylate gasoline, diesel fuel, jet fuel, base oil, and combinations thereof. Such hydrocarbon products may be derived from ionic liquid catalyzed hydrocarbon conversion processes (e.g., as described hereinabove with respect to FIG. 1). The hydrocarbon products may be contaminated with various organic halides, such as one or more C₂-C₁₆ alkyl chlorides.

The fresh adsorbent may be contacted with such hydrocarbon products in adsorption unit 150 under conditions suitable for the adsorption of organic halides from the hydrocarbon product. Such conditions may be referred to herein as organic halide adsorption conditions. As an example, the organic halide adsorption conditions may include a temperature in the range from about 32° F. to 500° F., a pressure in the range from about 1 to 1000 psig, and a liquid hourly space velocity (LHSV) feed rate in the range from about 0.1 to 40 hr⁻¹.

With continued use the adsorbent may become at least partially spent, e.g., as a result of adsorption by the adsorbent of organic halide contaminants of the hydrocarbon product(s). In an embodiment, the spent adsorbent may comprise at least one halogenated component, which may comprise, e.g., an organic halide adsorbate or a derivative thereof. The spent adsorbent may have substantially less alkyl chloride adsorption capacity as compared with that of the original, fresh adsorbent, such that the spent adsorbent may no longer provide a purified hydrocarbon product having an acceptably low chloride content. Absent rejuvenation processes according to embodiments of the present invention, such spent adsorbent may typically be discarded and disposed of.

Advantageously, the spent adsorbent may be treated using adsorbent rejuvenation processes according to embodiments of the present invention to provide rejuvenated adsorbent, wherein the organic halide adsorption capacity of the rejuvenated adsorbent is at least partially restored as a result of such rejuvenation.

Adsorbent rejuvenation processes according to embodiments of the present invention may involve contacting the spent adsorbent with a basic solution under conditions suitable for removing at least a portion of one or more halogenated components of the spent adsorbent. Such conditions may be referred to herein as adsorbent dechlorination conditions. In an embodiment, contacting the spent adsorbent with the basic solution under adsorbent dechlorination conditions may effectively remove at least a portion of the one or more halogenated components from the spent adsorbent to provide a dechlorinated adsorbent.

In an embodiment, a basic solution for treating the spent adsorbent may be prepared by dissolving a Group 1 or Group 2 metal hydroxide in a suitable solvent. As an example only, a polar solvent such as water may be used to prepare the basic solution. When water is used as solvent, the pH of the resulting basic solution may be greater than pH 7, in an embodiment greater than pH 9, and in another embodiment greater than 12. As an example, the basic solution may comprise a solution of a material selected from NaOH, KOH, RbOH, CsOH, Mg(OH)₂, Ca(OH)₂, Sr(OH)₂, Ba(OH)₂, and combinations thereof. In an embodiment, the basic solution may comprise NaOH solution, and in a sub-embodiment the NaOH solution may have a concentration in the range from about 0.01M to 10 M.

In an embodiment, contacting the spent adsorbent with the basic solution may involve extensively washing a bed of the adsorbent with the basic solution, for example, in order to remove from the adsorbent any contaminants that may cause a reduction in the organic halide adsorption capacity of the adsorbent. As a non-limiting example, during rejuvenation mode the adsorbent bed may be in fluid communication with a reservoir (not shown) of the basic solution such that the adsorbent bed and reservoir comprise a rejuvenation sub-system, and the basic solution may be circulated through the rejuvenation sub-system to wash the adsorbent bed with the basic solution.

In an embodiment, during the contacting step the adsorbent bed to be treated may be washed with at least one bed volume of the basic solution. The adsorbent may be contacted with the basic solution in a rejuvenation vessel, e.g., as represented by rejuvenation unit 150′ (FIG. 1). A ratio (V_{S}/V_{B}) of basic solution volume (V_{S}) to adsorbent bed volume (V_{B}) in rejuvenation unit 150′ during the contacting step may be in the range of 1-1000, 1-200, or 1-20. In an embodiment, contacting the adsorbent with the basic solution may comprise feeding the basic solution up-flow or down-flow through a bed of the spent adsorbent.

In an embodiment, the adsorbent dechlorination conditions for contacting the adsorbent with the basic solution may include a temperature typically in the range from about 35° F. to 200° F., a pressure in the range from about 1 to 400 psig, and a liquid hourly space velocity (LHSV) feed rate of the basic solution to the adsorbent bed in the range from about 0.1 to 100 hr⁻¹.

After contacting the spent adsorbent with the basic solution, the dechlorinated adsorbent may be activated to provide a rejuvenated adsorbent. Suitable conditions for the activation of the dechlorinated adsorbent may be referred to herein as adsorbent activation conditions. As a non-limiting example, adsorbent activation conditions may comprise a temperature in the range from about 100° F. to 1000° F., and typically from about 200° F. to 900° F., for a time period in the range from about 0.5 hr. to 24 hr. The adsorbent activation conditions may include a pressure generally in the range from about 1 to 400 psig. In an embodiment, an inert gas such as N₂ or air, or a C₁-C₄ saturated hydrocarbon may be blown to a bed of the adsorbent to reduce any degradation of the adsorbent or facile removal of moisture.

As a result of adsorbent rejuvenation according to embodiments of the instant invention, the alkyl chloride adsorption capacity of the rejuvenated adsorbent may be much greater than that of the spent adsorbent. In an embodiment, the alkyl chloride adsorption capacity of the rejuvenated adsorbent may be at least about 30%, and in another embodiment at least about 70%, of the alkyl chloride adsorption capacity of fresh adsorbent. Processes of the present invention may similarly be used to restore the adsorption capacity of spent adsorbents that have adsorbed organic halides other than chlorides. Typically, the alkyl chloride adsorption capacity of the spent adsorbent may be 50% or less, and often 25% or less, of the adsorption capacity of fresh adsorbent.

The rejuvenated adsorbent provided according to embodiments of the present invention may be reused for the purification of an unfinished hydrocarbon product to provide at least one purified hydrocarbon product. Moreover, adsorbent that has been rejuvenated according to embodiments of the instant invention may be repeatedly reused for hydrocarbon product purification processes. According to one aspect of the invention, no significant further diminution in alkyl chloride adsorption capacity of the rejuvenated adsorbent is observed after a plurality of sequentially repeated rejuvenation and adsorption cycles. As an example, the adsorption capacity of the rejuvenated adsorbent may be retained, at a level of at least about 70% of the original adsorption capacity of fresh adsorbent, after at least seven (7) repetitions of alkyl chloride adsorption and subsequent adsorbent rejuvenation.

In an embodiment, an adsorption unit 150 may comprise two or more adsorbent beds arranged in series and/or in parallel. Although adsorption unit 150 and adsorbent rejuvenation unit 150′ are shown separately in FIG. 1, units 150 and 150′ may represent the same equipment operated in different modes, namely adsorption mode and rejuvenation mode, respectively. For example, unit 150 may represent an adsorbent bed used in adsorption mode for the adsorption of organic halide from a hydrocarbon product, wherein the adsorbent becomes spent; while unit 150′ may represent the same adsorbent bed in rejuvenation mode for adsorbent rejuvenation.

The following examples are illustrative of the present invention, but do not limit the invention in any way beyond what is contained in the claims which follow.

### EXAMPLES

### Example 1

### Experimental Methods and Materials

A sample of adsorbent pellets containing 13× molecular sieve was purchased from W. R, Grace & Co. (Columbia, Md.). The 13× molecular sieve adsorbent (hereafter “13×”) was thermally activated by calcining it at 800° F. for 3 hours with a flow of dry air through a bed of the 13×, then the 13× was stored in a drying oven under dry nitrogen gas. The calcined 13× was handled carefully to minimize any adsorption of moisture from the atmosphere.

A model hydrocarbon solution, which comprised alkylate from an ionic liquid catalyzed alkylation process (as described hereinabove) and an excess of a combination of t-butyl chloride and 1-chlorobutane, was prepared to quantify the chloride adsorption capacity of 13× samples. The model hydrocarbon solution contained 14,125 ppm of organic chloride. The chloride content of hydrocarbon solutions used in Examples 2-4 was measured using X-ray Fluorescence Spectrometry (XRF).

### Example 2

### Non-Invention

### Decrease in Chloride Adsorption Capacity of 13× Molecular Sieve Adsorbent after Multiple Usage Cycles

The chloride adsorption capacity of fresh (unused, activated) 13× was determined as follows. A 96.2 g sample of fresh 13× (Example 1) was soaked in a 1 Liter aliquot of the model hydrocarbon solution (Example 1) for 24 hours under ambient conditions. During this time period, the chloride content of the hydrocarbon solution was reduced from an initial chloride concentration of 14,125 ppm to 1,180 ppm. The adsorption capacity of the 13× was measured by difference of the hydrocarbon solution chloride content. The chloride adsorption capacity of the 13× was calculated to be 0.1 g of Cl per g of 13×, which represents the adsorption capacity of the 13× in its first cycle of “use.”

The once-used 13× sample was then heated to 450° F. under a nitrogen stream for 3 hours and then cooled to ambient temperature. Then the cooled 13× was again soaked in an aliquot of the model hydrocarbon solution (as described above), and the chloride adsorption capacity of the 13× was re-measured. The adsorption capacity of the 13× for its second cycle of use was 0.05 g Cl per g of 13×.

The twice-used 13× sample was again heated to 450° F. under a nitrogen stream as described above, soaked in an aliquot of the model hydrocarbon solution, and the chloride adsorption capacity of the 13× was measured for its third cycle of use. The adsorption capacity of the 13× zeolite molecular sieve adsorbent for its third cycle of use was <0.01 g Cl per g of 13×.

The above procedure was repeated once more, and the adsorption capacity of the 13× in its fourth cycle of use was again determined to be <0.01 g Cl per g of 13×. This sample of 13×, which underwent multiple cycles of use with intervening thermal treatment, was spent.

### Example 3

### Rejuvenation of Spent 13× Molecular Sieve Adsorbent by Treatment with Aqueous NaOH Solution

### Invention

A sample of spent 13× was taken from a continuous chloride adsorption unit. The spent 13× sample was rejuvenated as follows.

A 153 gram sample of the spent 13× was placed in a cylindrical glass vessel. The sample was then hydrated by passing a moisture-saturated, ambient temperature N₂ stream through the 13× bed up-flow at 3 scf/hr. for 16 hours. A reservoir was filled with 700 mL of a 1 M (4 wt %) sodium hydroxide (NaOH) solution. The NaOH solution was pumped from the reservoir to the glass vessel and through the bed of spent 13× via up-flow at a rate of 70 mL/min at ambient temperature. The NaOH effluent was then returned to the reservoir to make a closed loop. The 13× bed was washed with the 1M NaOH solution in this manner for a total of 65 minutes. Then the NaOH solution was drained from the vessel, and the 13× bed was purged with N₂ until there was no visible moisture on the surface of the 13×. The 13× was then dried in an oven at 700° F. for 4 hours, with a N₂ flow through the bed, to provide a sample of rejuvenated 13×. After drying, the adsorption capacity of this sample of rejuvenated 13× was measured to be 0.07 g Cl per g of 13×.

By washing the spent 13× with the NaOH solution followed by activating the washed 13×, the capacity of the 13× for adsorption of organic chloride from an alkylate containing hydrocarbon solution was restored to 70% of the original adsorption capacity of the fresh 13× adsorbent (cf. Example 1).

### Example 4

### Multi-cycle Rejuvenation of Spent 13× Molecular Sieve Adsorbent by Treatment with Aqueous NaOH Solution

### Invention

The rejuvenated 13× (Example 3) was subjected to sequentially repeated cycles of organic chloride adsorption (by immersion of the 13× in the model hydrocarbon solution, as described in Example 2) and rejuvenation (as described in Example 3). After a total of seven (7) adsorption and rejuvenation cycles, the adsorption capacity of the 13× was again measured to be 0.07 g Cl per g of 13×, indicating no significant loss in adsorption capacity of the rejuvenated 13× after multiple cycles of adsorption and rejuvenation.

There are numerous variations on the present invention which are possible in light of the teachings and supporting examples described herein. It is therefore understood that within the scope of the following claims, the invention may be practiced otherwise than as specifically described or exemplified herein.

What is claimed is:

1. A process for treating a spent adsorbent, comprising:
a) contacting the spent adsorbent with a basic solution under adsorbent dechlorination conditions, wherein the spent adsorbent includes at least one halogenated component; and
b) via step a), removing at least a portion of the at least one halogenated component from the spent adsorbent to provide a dechlorinated adsorbent.

2. The process according to claim 1, further comprising:
c) activating the dechlorinated adsorbent to provide a rejuvenated adsorbent.

3. The process according to claim 2, further comprising:
d) after step c), contacting the rejuvenated adsorbent with a hydrocarbon product in an adsorption zone to provide the spent adsorbent, and after step d), sequentially repeating steps a)-d).

4. The process according to claim 1, wherein step a) comprises washing a bed of the spent adsorbent with at least one (1) bed volume of the basic solution.

5. The process according to claim 1, wherein step a) comprises feeding the basic solution up-flow or down-flow through a bed of the spent adsorbent.

6. The process according to claim 1, wherein step a) comprises circulating the basic solution through a rejuvenation sub-system comprising a bed of the spent adsorbent and a reservoir of the basic solution.

7. The process according to claim 1, wherein the basic solution comprises an aqueous solution of a Group 1 or Group 2 metal hydroxide.

8. The process according to claim 1, wherein the basic solution comprises a NaOH solution in the range from about 0.01M to 10M.

9. The process according to claim 1, wherein the adsorbent dechlorination conditions comprise a temperature in the range from about 35° F. to 200° F., a pressure in the range from about 1 to 400 psig, and a liquid hourly space velocity (LHSV) feed rate in the range from about 0.1 to 100 hr⁻¹.

10. The process according to claim 2, wherein step c) comprises exposing the dechlorinated adsorbent to a temperature in the range from about 100° F. to 1000° F. at a pressure in the range from about 1 to 400 psig for a time period in the range from about 0.5 to 24 hr.

11. The process according to claim 1, wherein the at least one halogenated component of the spent adsorbent comprises an organic halide adsorbate.

12. The process according to claim 11, wherein the organic halide adsorbate comprises a C₂-C₁₆ alkyl chloride.

13. The process according to claim 2, wherein a second alkyl chloride adsorption capacity of the rejuvenated adsorbent is at least about 30% of a first alkyl chloride adsorption capacity of a fresh adsorbent.

14. The process according to claim 1, wherein the adsorbent comprises a material selected from a molecular sieve, a refractory oxide, an activated carbon, and combinations thereof.

15. The process according to claim 1, wherein the adsorbent comprises a molecular sieve selected from the group consisting of large pore zeolites, intermediate pore zeolites, small pore zeolites, and combinations thereof.

16. The process according to claim 1, wherein the adsorbent comprises 13× molecular sieve.

17. A process, comprising:
a) contacting a hydrocarbon product comprising an organic halide with an adsorbent under organic halide adsorption conditions in an adsorption zone to provide a purified hydrocarbon product and a spent adsorbent, wherein a first chloride content of the hydrocarbon product is greater than a second chloride content of the purified hydrocarbon product;
b) contacting the spent adsorbent with a basic solution under adsorbent dechlorination conditions to provide a dechlorinated adsorbent; and
c) activating the dechlorinated adsorbent to provide a rejuvenated adsorbent.

18. The process according to claim 17, wherein the organic halide adsorption conditions comprise a temperature in the range from about 32° F. to 500° F., a pressure in the range from about 1 to 1000 psig, and a liquid hourly space velocity (LHSV) feed rate in the range from about 0.1 to 40 hr⁻¹.

19. The process according to claim 17, wherein:
the adsorbent dechlorination conditions comprise a temperature in the range from about 35° F. to 200° F., a pressure in the range from about 1 to 400 psig, and a liquid hourly space velocity (LHSV) feed rate in the range from about 0.1 to 100 hr⁻¹, and
step c) comprises exposing the dechlorinated adsorbent to a temperature in the range from about 100° F. to 1000° F. at a pressure in the range from about 1 to 400 psig for a time period in the range from about 0.5 to 24 hr.

20. The process according to claim 17, wherein:
the adsorbent comprises a molecular sieve, and
the basic solution comprises a solution of a material selected from the group consisting of NaOH, KOH, RbOH, CsOH, Mg(OH)₂, Ca(OH)₂, Sr(OH)₂, Ba(OH)₂, and combinations thereof.

21. The process according to claim 17, wherein step b) comprises feeding the basic solution through a bed of the spent adsorbent.

22. The process according to claim 21, wherein a ratio (V_{S}/V_{B}) of basic solution volume (V_{S}) to adsorbent bed volume (V_{B}) is in the range of 1-1000.

23. The process according to claim 17, wherein the hydrocarbon product is selected from the group consisting of alkylate gasoline, diesel fuel, jet fuel, base oil, and combinations thereof, and the purified hydrocarbon product has a chloride content less than 50 ppm.

24. A process for providing a purified hydrocarbon product, comprising:
a) contacting at least one hydrocarbon reactant with an ionic liquid catalyst in a hydrocarbon conversion zone under hydrocarbon conversion conditions to provide a hydrocarbon product comprising an organic halide contaminant;
b) contacting the hydrocarbon product with an adsorbent in an adsorption zone under organic halide adsorption conditions to provide: i) the purified hydrocarbon product and ii) a spent adsorbent;
c) contacting the spent adsorbent with a basic solution under adsorbent dechlorination conditions to provide a dechlorinated adsorbent; and
d) activating the dechlorinated adsorbent to provide a rejuvenated adsorbent.

25. The process according to claim 24, wherein:
the organic halide adsorption conditions comprise a temperature in the range from about 32° F. to 500° F., a pressure in the range from about 1 to 1000 psig, and a liquid hourly space velocity (LHSV) feed rate of the hydrocarbon product to the adsorption zone in the range from about 0.1 to 40 hr⁻¹;
the adsorbent dechlorination conditions include a temperature in the range from about 35° F. to 200° F., a pressure in the range from about 1 to 400 psig, and a liquid hourly space velocity (LHSV) feed rate in the range from about 0.1 to 100 hr⁻¹; and
step d) comprises exposing the dechlorinated adsorbent to a temperature in the range from about 100° F. to 1000° F. at a pressure in the range from about 1 to 400 psig for a time period in the range from about 0.5 to 24 hr.

26. The process according to claim 24, wherein:
the at least one hydrocarbon reactant comprises a first reactant comprising a C₄-C₁₀ isoparaffin and a second reactant comprising a C₂-C₁₀ olefin,
the hydrocarbon product comprises alkylate gasoline,
the ionic liquid catalyst comprises a chloroaluminate ionic liquid,
the adsorbent comprises a molecular sieve, and
the basic solution comprises aqueous NaOH.
